(19) United States
(12) Patent Application Publication
(10) Pub. No.: US 2019/0284764 A1
(43) Pub. Date: Sep. 19, 2019

(54) AUTOMATIC-CONTROL WET PAPER MOLDING MACHINE AND METHOD FOR PERFORMING THE SAME

(71) Applicant: GOLDEN ARROW PRINTING TECHNOLOGY (Kunshan) CO., LTD., Kunshan City (CN)

(72) Inventors: CHIEN-KUAN KUO, New Taipei City (TW); CHUN-HUANG HUANG, New Taipei City (TW)

(21) Appl. No.: 16/056,067

(22) Filed: Aug. 6, 2018

(30) Foreign Application Priority Data
Mar. 14, 2018 (TW) 107108527

(51) Int. Cl. D21J 3/00

(52) U.S. Cl. CPC D21J 3/00; B32B 9/06

(57) ABSTRACT

An automatic-control wet paper molding machine and a method for performing the same are introduced herein. The machine comprises a frame, a programmable control unit, at least one movable device, a first dredging-pulp operation section, a second dredging-pulp operation section and a thermo-compression forming operation section. The programmable control unit programmably controls the at least one movable device on sequent actuations, including firstly implementing synchronously dredging-pulp operations of the first and second dredging-pulp operation sections to respectively form a first pulp layer and second pulp layer; moving the first pulp layer to locate in the thermo-compression forming operation section and then moving the second pulp layer to overlap above the first pulp layer; and then implementing a thermo-compression on the overlapped first and second pulp layers to incorporate with each other to form a semi-finished product.

### FIELD OF THE INVENTION

The present invention relates to a technical field of an automatic-control wet-fiber paper molding, and more particularly, is related to an automatic-control wet paper molding machine and a method for performing the same.

### BACKGROUND OF THE INVENTION

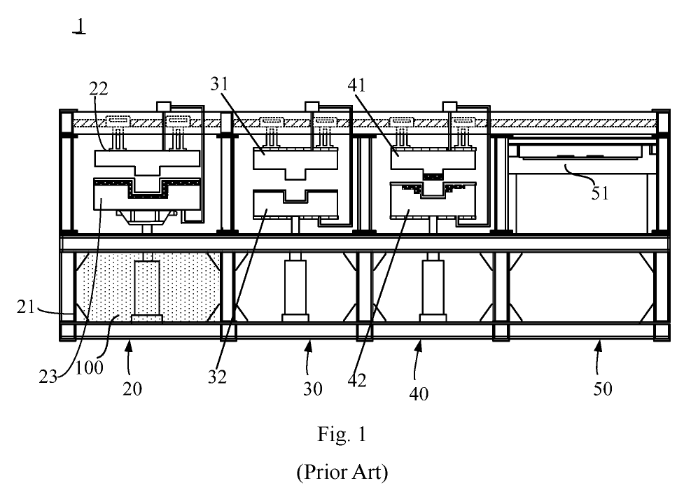

The inner and/or outer package productions for packing the existing 3C electronic products gradually adopted a wet-fiber paper molding technology where its principle includes employing a number of mold assemblies to rapidly and massively shape wet-fiber molded-paper products, each being in an integral form of a three-dimensional structure, from a large quantity of paper slurries. For example, a Taiwanese utility patent issued in No. M516,615 discloses a conventional wet paper molding machine 1, as illustrated in FIG. 1 below, which is primarily constructed of: a single dredging-pulp operation section 20 which utilizes a first lower mold 23 to dredge up first paper slurries 100 from within a single first slurry tank 21 so as to form a wet-pulp layer on an upper surface of the first lower mold 23, and then implements a first pre-compression step of applying a upward-and-downward compression on the wet pulp between the first lower mold 23 and a corresponding first upper mold 22 in a closing-mold manner, thereby forming a wet base; a first thermo-compression forming operation section 30, neighbored to the first dredging-pulp operation section 20, which implements a pre-thermo-compression forming step of applying a heating-compression on the wet base between a second upper mold 31 and a corresponding second lower mold 32 in a closing-mold manner, thereby forming a second semi-finished product; a second thermo-compression forming operation section 40, neighbored to the first thermo-compression forming operation section 30, which implements a thermo-compression forming step of applying another heating-compression on the second semi-finished product between a third upper mold 41 and a corresponding third lower mold 42 in a closing-mold manner, thereby forming a third semi-finished product; and a cutting operation section 50, neighbored to the second thermo-compression forming operation section 40, which implements a cutting step of utilizing at least one cutting mold 51 to trim the third semi-finished product, so as to form a molded-paper product.

Currently, there are demands to produce a molded-paper product which comprises a cross-sectional structure having double molded-paper layers, including an upper-layer molded-paper structure and a lower-layer molded-paper structure. However, the upper-layer molded-paper structure and the lower-layer molded-paper structure stacked in the double-layer cross-section should be different from each other in their respective overall sizes. If said conventional wet paper molding machine 1 is utilized to produce such a molded-paper product which comprises a cross-sectional structure having double molded-paper layers, it might incur one of the following matters:

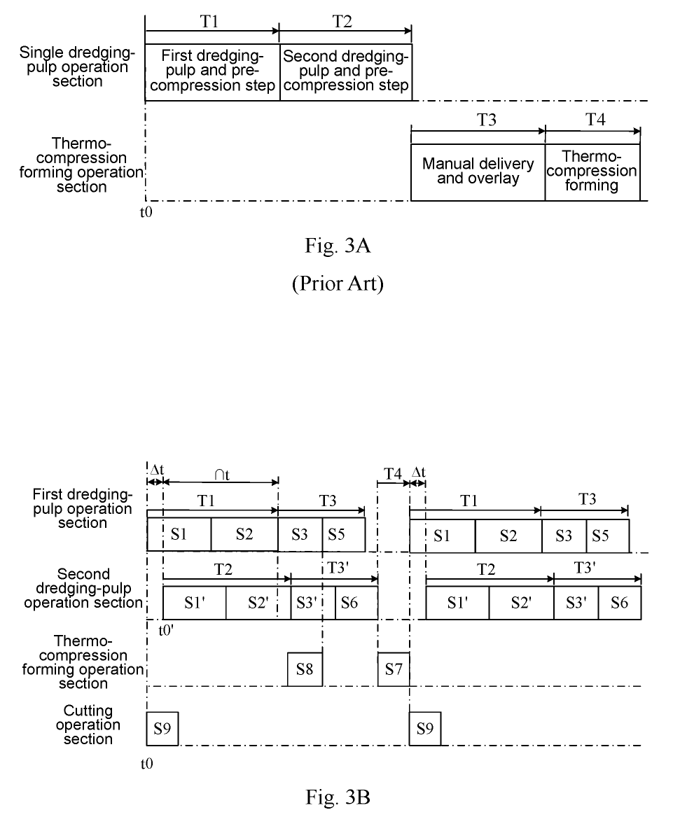

(1) Since the first dredging-pulp operation section 20 of said conventional wet paper molding machine 1 has an operation space merely enough to accommodate an operation of a set of mold assembly therein, it is necessary to dispose two sets of different-dimension mold assemblies in sequences and apart from each other in the machine 1, so as to individually shape the two upper-layer and lower-layer molded-paper structures within two non-interleaving time periods. In a case, please further refer to FIG. 3A, which indicates an operating sequence diagram of the respective operation sections of the conventional wet paper molding machine 1 as illustrated in FIG. 1, wherein firstly the first dredging-pulp operation section 20 is disposed with only a first set of mold assembly 22, 23, and the first set of mold assembly 22, 23 are set in an operation to shape the respective lower-layer molded-paper structure formed for each first duty cycle T1 (which is taken for implementations of a first dredging-pulp and pre-compression step). After the respective lower-layer molded-paper structures are formed, it is necessary to take a little extra time to manually replace the first set of mold assembly 22, 23 with disposition (including adjustment and calibration) of a second set of different-dimension mold assembly within the first dredging-pulp operation section 20, and to extra set the second set of mold assembly in an operation to shape the respective upper-layer molded-paper structure formed for each second duty cycle T2 (which is taken for implementations of a second dredging-pulp and pre-compression step). However, such an application would make that there is no time period interleaved between the first duty cycle T1 and the second duty cycle T2, thereby causing its overall duty cycle becoming extended for producing both of the upper-layer molded-paper structure and the lower-layer molded-paper structure. Furthermore, the respective upper-layer molded-paper structure and the respective lower-layer molded-paper structure individually moved out from the first dredging-pulp operation section 20 are delivered to the next thermo-compression forming operation section 40, by manual, so as to manually overlap with each other in a stack within the thermo-compression forming operation section 40 (It needs to take a duty cycle T3). Next, a third set of mold assembly 41, 42 is utilized to apply an upward-and-downward thermo-compression on the overlapped upper and lower layers of the molded-paper structures, thereby incorporating with each other to form a semi-finished product (It needs to take a duty cycle T4). However, the above-introduced conventional approach would take a huge processing time and more labor cost, which is not very beneficial to an operating efficiency required during massively producing the molded-paper products by the automated machine; and

(2) In another case that said conventional wet paper molding machine 1 is applied, the first dredging-pulp operation section 20 is disposed with the same set of mold assembly 22, 23 to respectively shape the upper-layer and lower-layer molded-paper structures. For example, the same set of mold assembly 22, 23 is set in an operation to shape the lower-layer molded-paper structure for the first duty cycle T1 (which is taken for implementations of a first dredging-pulp step and a first pre-compression step). After the respective lower-layer molded-paper structures are formed, the same set of mold assembly 22, 23 is set in another operation to continuously shape the upper-layer molded-paper structure for the second duty cycle T2 (which is taken for implementations of a second dredging-pulp step and a second pre-compression step). However, there is still no time period interleaved between the first duty cycle T1 and the second duty cycle T2, thereby still extending its overall duty cycle for producing both of the upper-layer molded-paper structure and the lower-layer molded-paper structure. Thus, extending its overall duty cycle would be not beneficial to an operating efficiency required during massively producing the molded-paper products by the automated machine; besides, molding of the same set of mold assembly 22, 23 can not shape accurately different molded dimensions required respectively for both of the upper layer and the lower layer in the molded-paper structures.

Therefore, it is essential to provide an improved automatic-control wet paper molding machine so as to solve the above-mentioned drawbacks of the prior arts.

### SUMMARY OF THE INVENTION

In order to solve a variety of technical matters incurred in said conventional wet paper molding machine, a primary objective of the present invention is to provide an automatic-control wet paper molding machine and a method for performing the same, which are suitable to massively and rapidly automation-produce a molded-paper product which comprises a cross-sectional structure having double molded-paper layers.

Furthermore, another objective of the present invention is to provide an automatic-control wet paper molding machine and a method for performing the same, which utilize a programmable control unit to programmably control at least one movable device on actuating, in sequences, a first dredging-pulp operation section and a second dredging-pulp operation section both synchronously dredging pulps to respectively form a first pulp layer and a second pulp layer, then the first pulp layer being moved into a thermo-compression forming operation section, and then the second pulp layer being moved to overlap above the first pulp layer in the thermo-compression forming operation section, and then the overlapped first and second pulp layers being thermo-compressed to incorporate with each other to form a semi-finished product, thereby being capable of shortening the overall duty cycle and labor costs thereof, elevating an operating efficiency, and shaping accurately different dimensions required respectively for both of the upper and lower layers in the molded-paper structures.

To accomplish said objectives, the present invention provides an automatic-control wet paper molding machine, which is primarily constructed of a frame, at least one movable device, a first dredging-pulp operation section, a second dredging-pulp operation section, a thermo-compression forming operation section, and a programmable control unit. The at least one movable device is disposed within the frame and electrically connected to the programmable control unit. The first dredging-pulp operation section is mechanically connected to the at least one movable device and is disposed with a first slurry tank, a first upper mold and a first lower mold, wherein the programmable control unit depends on a first duty cycle to programmably control the at least one movable device on actuating either of the first upper mold and the first lower mold to dredge up first paper slurries from within the first slurry tank, thereby forming a first pulp layer.

The second dredging-pulp operation section is mechanically connected to the at least one movable device and is disposed with a second slurry tank, a second upper mold and a second lower mold, wherein the programmable control unit depends on a second duty cycle to programmably control the at least one movable device on actuating either of the second upper mold and the second lower mold to dredge up second paper slurries from within the second slurry tank, thereby forming a second pulp layer, wherein there is at least one time period interleaved between the first duty cycle and the second duty cycle.

The thermo-compression forming operation section, neighbored to both of the first dredging-pulp operation section and the second dredging-pulp operation section and mechanically connected to the at least one movable device, has a third upper mold and a third lower mold therein, wherein the programmable control unit depends on a predetermined actuation sequences to firstly programmably control the at least one movable device on actuating the first upper mold bringing the first pulp layer to move together from the first dredging-pulp operation section to reach the thermo-compression forming operation section, for positioning the first pulp layer to the third lower mold, then programmably control the at least one movable device on actuating the second upper mold bringing the second pulp layer to move together from the second dredging-pulp operation section to reach the thermo-compression forming operation section, for positioning the second pulp layer to overlap above the first pulp layer, and then programmably control the at least one movable device on actuating both of the third lower mold and the third upper mold in applying a thermo-compression on the overlapped first and second pulp layers, thereby incorporating with each other to form a semi-finished product.

In a preferred embodiment of the present invention, the programmable control unit depends on the first duty cycle to programmably control the at least one movable device on actuating either of the first upper mold and the first lower mold in a first dredging-pulp to dredge up the first paper slurries from within the first slurry tank and thereby form a first wet pulp, and then programmably control said at least one movable device on actuating both of the first lower mold and the first upper mold in applying a first pre-compression on the first wet pulp to form the first pulp layer.

In a preferred embodiment of the present invention, the programmable control unit depends on the second duty cycle to programmably control the at least one movable device on actuating either of the second upper mold and the second lower mold in a second dredging-pulp to dredge up the second paper slurries from within the second slurry tank and thereby form the second wet pulp, and then programmably control said at least one movable device on actuating both of the second lower mold and the second upper mold in applying a second pre-compression on the second wet pulp to form the second pulp layer.

In a preferred embodiment of the present invention, the automatic-control wet paper molding machine further comprises at least one vacuum intaking device, wherein the programmable control unit programmably controls the at least one vacuum intaking device on respectively, absorbing water/moistures contained within the first wet pulp, the second wet pulp, and the overlapped first and second pulp layers, and further programmably controls the at least one vacuum intaking device on respectively suctioning the first pulp layer, via a number of through vents formed within the first upper mold, to be moved together with bringing of the first upper mold, and suctioning the second pulp layer, via a number of through vents formed within the second upper mold, to be moved together with bringing of the second upper mold.

In a preferred embodiment of the present invention, the automatic-control wet paper molding machine further comprises a cutting operation section, which is disposed within the frame and neighbored to the thermo-compression forming operation section, having at least one cutting mold assembly, wherein the programmable control unit depends on the predetermined actuation sequences to firstly programmably control the at least one movable device on actuating the third upper mold bringing the semi-finished product to move together from the thermo-compression forming operation section to reach the cutting operation section, for positioning the semi-finished product into between the at least one cutting mold assembly, and then programmably control the at least one movable device on actuating the at least one cutting mold assembly in cutting the semi-finished product.

In a preferred embodiment of the present invention, the programmable control unit comprises at least one programmable controller and a number of sensors electrically connected to the at least one programmable controller, wherein the at least one programmable controller is configured to control said actuations of the at least one movable device, and the number of sensors are configured to respectively sense a physical information relative to said respective controlled actuations of the at least one movable device and then feedback the physical information to the at least one programmable controller.

In a preferred embodiment of the present invention, the first paper slurries and the second paper slurries both have different colors.

In a preferred embodiment of the present invention, the first paper slurries and the second paper slurries both have different average fiber lengths or compositions.

In a preferred embodiment of the present invention, the first lower mold and the third lower mold both have the same or similar dimensions, and the second upper mold and the third upper mold both have the same or similar dimensions.

In a preferred embodiment of the present invention, the first lower mold has a first dredging-pulp reverse device, and the second lower mold has a second dredging-pulp reverse device, wherein the programmable control unit programmably controls the first dredging-pulp reverse device on actuating the first lower mold being rotated by 180 degrees to either sink into or leave far away from the first paper slurries, and the programmable control unit programmably controls the second dredging-pulp reverse device on actuating the second lower mold being rotated by 180 degrees to either sink into or leave far away from the second paper slurries.

Besides, the present invention further provides an automatic-control wet paper molding method, comprises the following steps:

utilizing a programmable control unit to synchronously implement a first dredging-pulp step and a second dredging-pulp step, wherein the first dredging-pulp step further comprises utilizing the programmable control unit depending on a first duty cycle to programmably control at least one movable device on actuating either of a first upper mold and a first lower mold to dredge up first paper slurries from within a first slurry tank and thereby form a first pulp layer thereon, and the second dredging-pulp step further comprises utilizing the programmable control unit depending on a second duty cycle to programmably control the at least one movable device on actuating either of a second upper mold and a second lower mold to dredge up second paper slurries from within a second slurry tank and thereby form a second pulp layer thereon, wherein there is at least one time period interleaved between the first duty cycle and the second duty cycle; and

utilizing the programmable control unit to programmably implement the following steps in sequences, comprising:

programmably implementing a first trans-regional move step which comprises utilizing the programmable control unit to programmably control the at least one movable device on actuating the first upper mold bringing the first pulp layer to move together into a third lower mold, thereby positioning the first pulp layer to the third lower mold;

then programmably implementing a second trans-regional move step which comprises utilizing the programmable control unit to programmably control the at least one movable device on actuating the second upper mold bringing the second pulp layer to move together into the third lower mold, thereby positioning the second pulp layer to overlap above the first pulp layer; and

then programmably implementing a thermo-compression forming step which comprises utilizing the programmable control unit to programmably control the at least one movable device on actuating both of a third upper mold and a third lower mold in applying an upward-and-downward thermo-compression on the overlapped first and second pulp layers, thereby incorporating with each other to form a semi-finished product.

In a preferred embodiment of the present invention, the automatic-control wet paper molding method further comprises: utilizing the programmable control unit depending on the first duty cycle to implement the following steps in sequences, comprising:

the first dredging-pulp step which comprises programmably controlling the at least one movable device on actuating either of the first upper mold and the first lower mold in a first dredging-pulp to dredge up the first paper slurries from within the first slurry tank, thereby forming a first wet pulp;

then programmably controlling at least one vacuum intaking device on absorbing water/moistures contained within the first wet pulp; and

then programmably controlling the at least one movable device on actuating both of the first lower mold and the first upper mold in implementing a step of applying a first pre-compression on the first wet pulp to form the first pulp layer.

In a preferred embodiment of the present invention, the automatic-control wet paper molding method further comprises utilizing the programmable control unit depending on the second duty cycle to implement the following steps in sequences, comprising:

the second dredging-pulp step which comprises firstly programmably controlling the at least one movable device on actuating either of the second upper mold and the second lower mold in a second dredging-pulp to dredge up the second paper slurries from within the second slurry tank, thereby forming a second wet pulp;

then programmably controlling the at least one vacuum intaking device on absorbing water/moistures contained within the second wet pulp; and

then programmably controlling the at least one movable device on actuating both of the second lower mold and the second upper mold in implementing a step of applying a second pre-compression on the second wet pulp to form the second pulp layer.

In a preferred embodiment of the present invention, the thermo-compression forming step further comprises utilizing the programmable control unit to programmably control the at least one vacuum intaking device on absorbing water/moistures contained within the overlapped first and second pulp layers, the first trans-regional move step further comprises utilizing the programmable control unit to programmably control the at least one vacuum intaking device on suctioning the first pulp layer, via a number of through vents formed within the first upper mold, to be moved together with bringing of the first upper mold, and the second trans-regional move step further comprises utilizing the programmable control unit to programmably control the at least one vacuum intaking device on suctioning the second pulp layer, via a number of through vents formed within the second upper mold, to be moved together with bringing of the second upper mold.

In a preferred embodiment of the present invention, synchronous implementations of both of the first dredging-pulp step and the second dredging-pulp step is defined in a manner that the first dredging-pulp step and the second dredging-pulp step both start implementation at the same time or different time which there is a constant time interval between.

In a preferred embodiment of the present invention, the automatic-control wet paper molding method further comprises programmably implementing a third trans-regional move step which comprises utilizing the programmable control unit to programmably control the at least one movable device on actuating the third upper mold bringing the semi-finished product to move together, and then positioning the semi-finished product into between at least one cutting mold assembly.

In a preferred embodiment of the present invention, the automatic-control wet paper molding method further comprises programmably implementing a cutting step which comprises utilizing the programmable control unit to programmably control the at least one movable device on actuating the at least one cutting mold assembly in cutting the semi-finished product.

In a preferred embodiment of the present invention, the first dredging-pulp step further comprises utilizing the programmable control unit to programmably control a first dredging-pulp reverse device on actuating the first lower mold being rotated by 180 degrees to either sink into or leave far away from the first paper slurries, and the second dredging-pulp step further comprises: utilizing the programmable control unit to programmably control a second dredging-pulp reverse device on actuating the second lower mold being rotated by 180 degrees to either sink into or leave far away from the second paper slurries.

Besides, the present invention further provides a molded-paper product which is fabricated by said automatic-control wet paper molding method according to said respective preferred embodiments. The molded-paper product comprises a cross-sectional structure having double molded-paper layers.

A beneficial effect of the present invention is that: compared with the prior arts, the automatic-control wet paper molding machine and the automatic-control wet paper molding method according to the present invention are very suitable to massively and rapidly automation-produce a molded-paper product which comprises a cross-sectional structure having double molded-paper layers, and especially in utilizing the programmable control unit to programmably control the following steps in sequences, comprising: synchronizing dredging-pulp operations of both the first dredging-pulp operation section and the second dredging-pulp operation section, thereby rapidly forming the first pulp layer and the second pulp layer, then moving the first pulp layer to a thermo-compression forming operation section, then moving the second pulp layer to overlap above the first pulp layer within thermo-compression forming operation section, and then implementing a thermo-compression on the overlapped first and second pulp layers and thereby incorporating with each other to form a semi-finished product, so as to shorten the overall duty cycle and labor costs, elevate an operating efficiency thereof, and shape accurately different dimensions required respectively for the double molded-paper layers of the cross-sectional structure of the molded-paper product.

### DESCRIPTION OF THE DIAGRAMS

The above and other objects, features, and advantages of the invention will be better understood from the following detailed description thereof when it is considered in conjunction with the accompanying drawings in which:

FIG. 1 illustrates a lateral-side schematic view of a conventional wet paper molding machine;

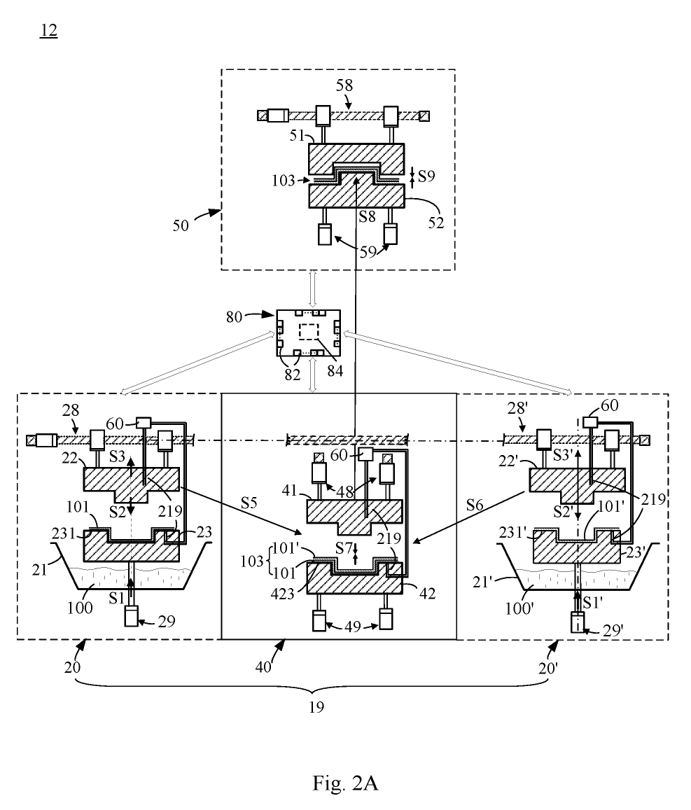

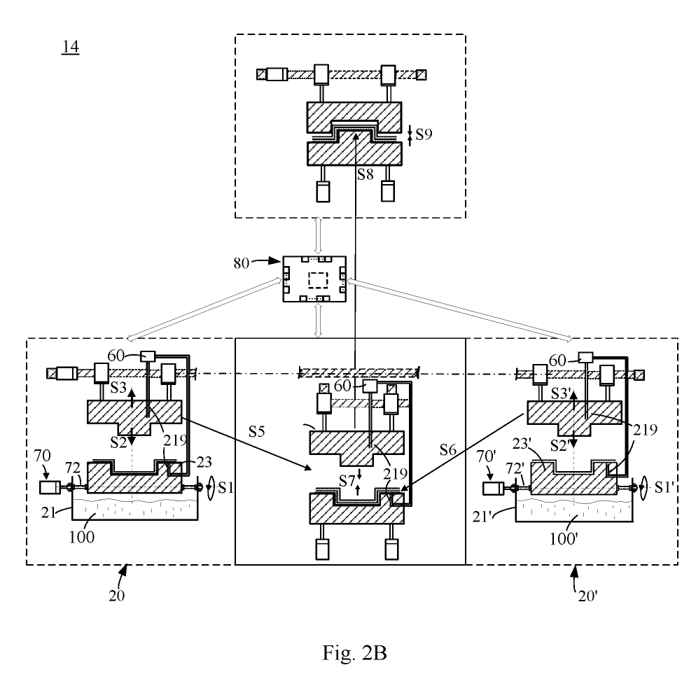

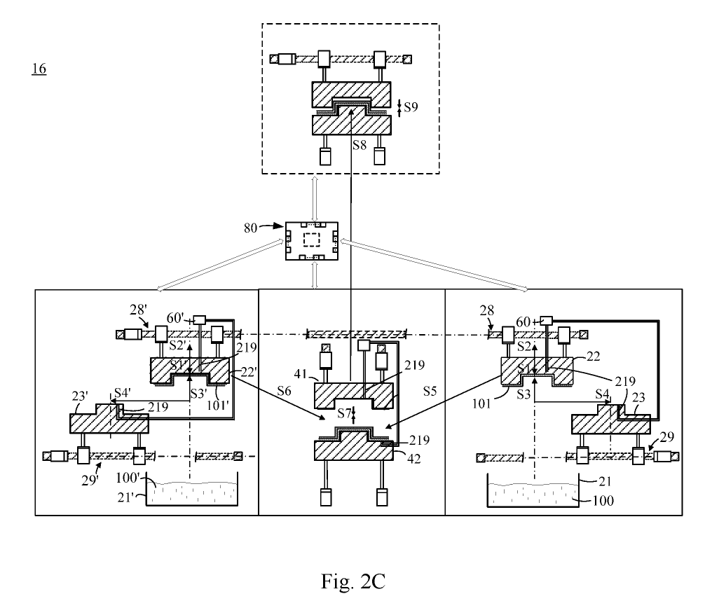

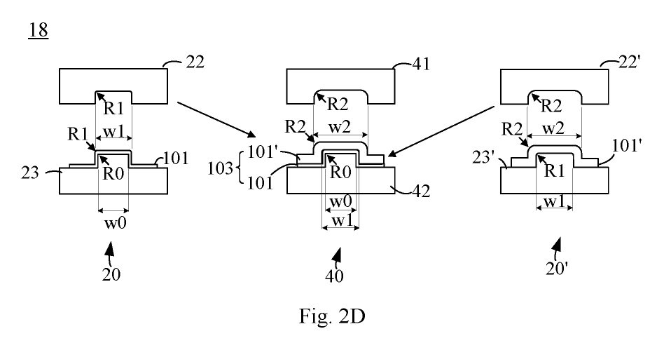

FIG. 2A illustrates a structurally schematic diagram of an automatic-control wet paper molding machine of a first preferred embodiment according to the present invention;

FIG. 2B illustrates a structurally schematic diagram of an automatic-control wet paper molding machine of a second preferred embodiment according to the present invention;

FIG. 2C illustrates a structurally schematic diagram of an automatic-control wet paper molding machine of a third preferred embodiment according to the present invention;

FIG. 2D illustrates a simplified schematically-structural diagram of an automatic-control wet paper molding machine of a fourth preferred embodiment according to the present invention;

FIG. 3A illustrates an operating sequence diagram regarding the respective operation sections of the conventional wet paper molding machine illustrated in FIG. 1, for producing a molded-paper product with a cross-sectional structure having double molded-paper layers;

FIG. 3B illustrates a controlled-operation sequence diagram of the respective operation sections of the automatic-control wet paper molding machine according to the present invention illustrated in FIG. 2A, for producing a molded-paper product with a cross-sectional structure having double molded-paper layers;

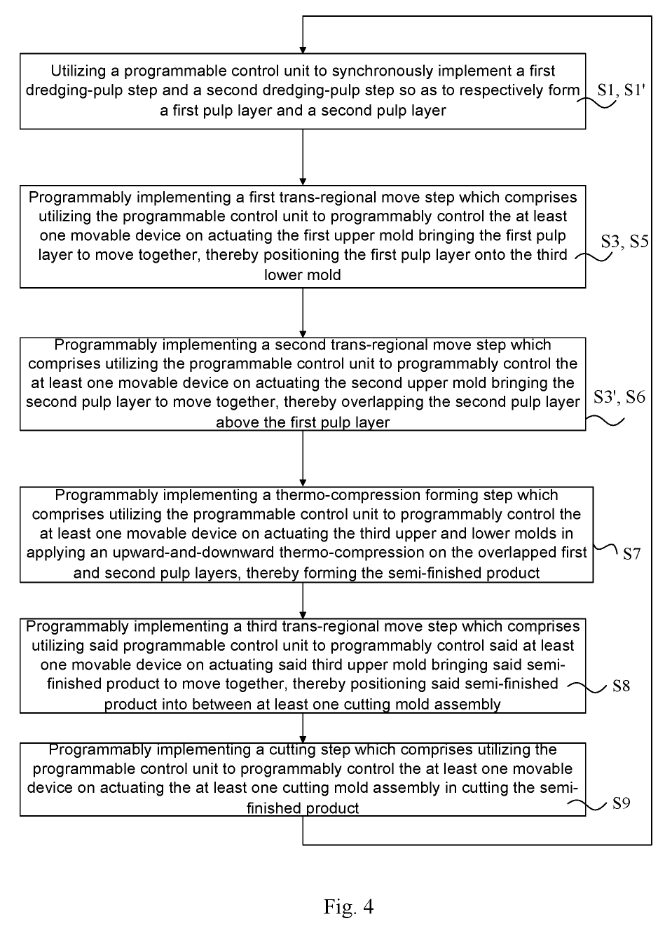

FIG. 4 illustrates a flow chart of an automatic-control wet paper molding method according to the present invention; and

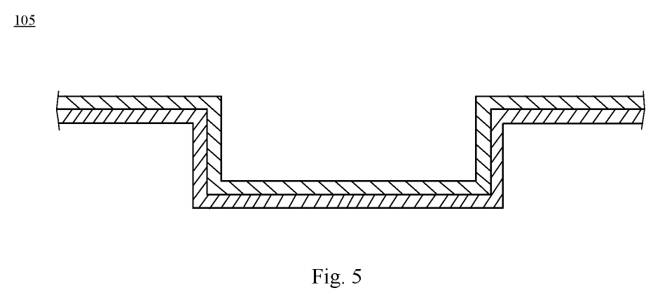

FIG. 5 illustrates a laterally cross-sectional diagram of the molded-paper product fabricated by the automatic-control wet paper molding method according to FIG. 4, wherein the molded-paper product comprises a cross-sectional structure having double molded-paper layers.

### DETAILED DESCRIPTION OF THE PREFERRED EMBODIMENTS

The following description of the embodiments is given by way of illustration with reference to the specific embodiments in which the invention may be practiced. The use of any directional term is used to describe and to understand the present invention and is not intended to limit the invention.

Please firstly refer to an illustration in FIG. 2A, which illustrates a structurally schematic diagram of an automatic-control wet paper molding machine 12 of a first preferred embodiment according to the present invention. The automatic-control wet paper molding machine 12, suitable to automatically produce a molded-paper product with a cross-sectional structure having double molded-paper layers, is primarily structured with: a frame 19, a programmable control unit 80, at least one movable device 28, 28′, 29, 29′, 48, 49, 58, 59, a first dredging-pulp operation section 20, a second dredging-pulp operation section 20′, a thermo-compression forming operation section 40 and a cutting operation section 50.

Said frame 19 has a typical supporting-rack structure which is constructed to accommodate therein the at least one movable device 28, 28′, 29, 29′, 48, 49, 58, 59, the first dredging-pulp operation section 20, the second dredging-pulp operation section 20′, the thermo-compression forming operation section 40 and the cutting operation section 50. The at least one movable device 28, 28′, 29, 29′, 48, 49, 58, 59 is diverged to spread over corresponding upper and/or lower edges of each of the first dredging-pulp operation section 20, the second dredging-pulp operation section 20′, the thermo-compression forming operation section 40 and the cutting operation section 50. In this preferred embodiment, the at least one movable device 28, 28′, 29, 29′, 48, 49, 58, 59 may include a number of running-alone move devices 28, 28′, 29, 29′, 48, 49, 58, 59 each instructed with various kind of conventional actuator such as an actuating motor, robotic arms, lead screws or ball screws driven by the actuating motor, and pneumatic cylinders/hydraulic cylinder, for respectively actuating or transporting the respective molds collocated within the first dredging-pulp operation section 20, the second dredging-pulp operation section 20′, the thermo-compression forming operation section 40 and the cutting operation section 50; or is a single moving system which is incorporated with a number of movable devices 28, 28′, 29, 29′, 48, 49, 58, 59 as actuating elements each having a mold-actuation or mold-transport function for circulation of the overall system. In different embodiments, each of the move devices 28, 28′, 29, 29′, 48, 49, 58, 59 can also utilize a number of conventional sliding rails to form assembled with a number of corresponding sliding blocks to accomplish sliding movements relative to each other. Since it is a conventional technology to design each of the at least one movable devices 28, 28′, 29, 29′, 48, 49, 58, 59 as an actuation structure, depending upon actual demands, which moves in a horizontal movement, a vertical movement or a three-dimension movement, it will be omitted hereinafter. However, regardless of a number of running-alone move devices 28, 28′, 29, 29′, 48, 49, 58, 59 or a single moving system incorporated with a number of move devices 28, 28′, 29, 29′, 48, 49, 58, 59, since each of the move devices 28, 28′, 29, 29′, 48, 49, 58, 59 are respectively electrically connected to the programmable control unit 80, for reception of programmable control commands from the programmable control unit 80. By unity conduct and coordination of the programmable control unit 80, the move devices 28, 28′, 29, 29′, 48, 49, 58, 59 all can act together as a circulated single system so as to synchronously implement a number of tasks.

Further referring to the illustration in FIG. 2A for the first preferred embodiment according to the present invention, the programmable control unit 80 comprises at least one programmable controller 84 and a number of sensors 82 electrically connected to the at least one programmable controller 84. The at least one programmable controller 84 is configured to provide various kinds of controls (detailed later) for actuations of the at least one movable device 28, 28′, 29, 29′, 48, 49, 58, 59. The number of sensors 82 are configured to respectively sense at least one physical information (e.g. pressure values or shifting values) relative to the respective controlled actuations of the at least one movable device 28, 28′, 29, 29′, 48, 49, 58, 59, and then to feedback the physical information to the at least one programmable controller 84, for further determination and proceeding.

Referring to the illustrations in FIGS. 2A and 3B, the first dredging-pulp operation section 20 that is disposed beside thermo-compression forming operation section 40 and mechanically connected to the at least one movable device 28, 29, has a first slurry tank 21 for storing first paper slurries 100, a first upper mold 22 and a first lower mold 23, wherein the programmable control unit 80 depends on a first duty cycle T1 (as referring to FIG. 3B) to programmably control the at least one movable device 28, 29 on respectively actuating either of the first upper mold 22 and the first lower mold 23, to dredge up the first paper slurries 100 from within the first slurry tank 21, thereby forming a first pulp layer 101. Concretely, the programmable control unit 80 depends on the first duty cycle T1 (as referring to FIG. 3B) to sequentially, programmably control the at least one movable device 29 on actuating the first lower mold 23 in implementing a first dredging-pulp such that an upward dredging-pulp surface of the first lower mold 23 is actuated to dredge up the first paper slurries 100 from the first slurry tank 21 so as to form a wet pulp, then programmably control the at least one movable device 28, 29 on actuating both of the first lower mold 23 and the first upper mold 22 in a closing-mold manner for upwardly-and-downwardly implementing a first pre-compression (as a light compression) on the first wet pulp to form a first pulp layer 101 with an initial shape thereof, and then programmably control the at least one movable device 28 on actuating the first upper mold 22 bringing the first pulp layer 101 to move together into the thermo-compression forming operation section 40.

Further referring to the illustrations of FIGS. 2A and 3B, the second dredging-pulp operation section 20′ disposed on alternative side of thermo-compression forming operation section 40 and mechanically connected to the at least one movable device 28′, 29′, has a second slurry tank 21′ storing second paper slurries 100′, a second upper mold 22′ and a second lower mold 23′, wherein the programmable control unit 80 depends on a second duty cycle T2 (as referring to FIG. 3B) to programmably control the at least one movable device on 28′, 29′ on actuating either of the second upper mold 22′ and the second lower mold 23′, to dredge up second paper slurries 100′ from the second slurry tank 21′, thereby forming a second pulp layer 101′. Concretely, the programmable control unit 80 depends on the second duty cycle T2 (as referring to FIG. 3B) to sequentially, programmably control the at least one movable device 29′ on actuating the second lower mold 23′ in implementing a second dredging-pulp such that an upward dredging-pulp surface of the second lower mold 23′ is actuated to dredge up the second paper slurries 100′ from the second slurry tank 21′ so as to form a second wet pulp, then programmably control the at least one movable device 28′, 29′ on actuating both of the second lower mold 23′ and the second upper mold 22′ in a closing-mold manner for upwardly-and-downwardly implementing a second pre-compression (as a light compression) on the second wet pulp to form a second pulp layer 101′ with an initial shape, and then programmably control the at least one movable device 28′ on actuating the first upper mold 22′ bringing the second pulp layer 101′ to move together into the thermo-compression forming operation section 40.

Please further refer to the illustrations of FIGS. 2A and 3B. It is found that, there is at least one time period n t interleaved between the first duty cycle T1 and the second duty cycle T2, namely that, the first dredging-pulp operation section 20 and the second dredging-pulp operation section 20′ both can implement synchronously their dredging-pulp operations under programmable controls of the programmable control unit 80. The term ‘synchronously dredging-pulp” is defined in a manner that the first dredging-pulp action and the second dredging-pulp action both respectively start implementations at different beginning time t0, t0′, between which there is a constant time interval Δt (Δt>0) existed, and then their actions are repeated for the next duty cycle. However, in other embodiments, the term ‘synchronously dredging-pulp’ is also defined in another manner that the first dredging-pulp action and the second dredging-pulp action both respectively start implementations at the same beginning time t0, t0′ (e.g. t0=t0′), for simultaneously starting to implement their dredging-pulp operations. In one preferred embodiment of the present invention, the first paper slurries 100 in the first dredging-pulp operation section 20 and the second paper slurries 100′ in the second dredging-pulp operation section 20′ both have different colors, thereby being capable of producing a molded-paper product 105 (as referring to FIG. 5) which has a cross-sectional structure with dual-colored layers. In another preferred embodiment of the present invention, depending upon different demands on different products, the first paper slurries 100 and the second paper slurries 100′ both have different average fiber lengths and/or compositions.

Further referring to the illustrations of FIGS. 2A and 3B, the thermo-compression forming operation section 40 mechanically connected to the at least one movable device 48, 49 has a third upper mold 41 and a third lower mold 42, wherein the programmable control unit 80 depends on a predetermined actuation sequence to implement multiple programmable controls in sequences as follows. Firstly the programmable control unit 80 depends on the predetermined actuation sequence to programmably control the at least one movable device 28 on actuating the first upper mold 22 bringing the first pulp layer 101 to move together from the first dredging-pulp operation section 20 to reach the thermo-compression forming operation section 40 and then positioning the first pulp layer 101 above a top surface of the third lower mold 42 of the thermo-compression forming operation section 40 (and then the first upper mold 22 being moved alone and back to the first dredging-pulp operation section 20), and then programmably control the at least one movable device 28′ on actuating the second upper mold 22′ bringing the second pulp layer 101′ to move together from the second dredging-pulp operation section 20′ to reach the thermo-compression forming operation section 40 and then positioning the second pulp layer 101′ to overlap above the first pulp layer 101 in the thermo-compression forming operation section 40 (and then the second upper mold 22′ being moved alone and back to the second dredging-pulp operation section 20′), and then programmably control the at least one movable device 48, 49 on actuating both of the third upper mold 41 and the third lower mold 42 in implementing an upward-and-downward heating and deeper compression on the overlapped first and second pulp layers 101, 101′ to incorporate with each other into a semi-finished product 103. During a period when the at least one movable device 48, 49 on actuating both of the third upper mold 41 and the third lower mold 42 upwardly-and-downwardly, deeply compressing the overlapped first and second pulp layers 101, 101′ for incorporating with each other into the semi-finished product 103, a heating device respectively disposed within the third upper mold 41 and the third lower mold 42 is employed to heat the overlapped first and second pulp layers 101, 101′ for accelerating dryness thereof, and the heating device may be a conventional heating plate (not shown).

Further referring to the illustration of FIG. 2A for the first preferred embodiment according to the present invention, the automatic-control wet paper molding machine further comprises a cutting operation section 50, neighbored to the thermo-compression forming operation section 40 and mechanically connected to the at least one movable device 58, 59, has at least one cutting mold assembly 51, 52, wherein the programmable control unit 80 depends on the predetermined actuation sequence to programmably control the following steps in sequences, including: firstly programmably controlling the at least one movable device 48 on actuating the third upper mold 41 bringing the semi-finished product 103 to move together from the thermo-compression forming operation section 40 to reach the cutting operation section 50 and then positioning the semi-finished product 103 into between the at least one cutting mold assembly 51, 52 (and then the third upper mold 41 being moved alone and back to the thermo-compression forming operation section 40), and then programmably controlling the at least one movable device 58, 59 on actuating the at least one cutting mold assembly 51, 52 in upwardly-and-downwardly cutting the semi-finished product 103, for forming a molded-paper product 105 (as referring to FIG. 5) as a finished product.

Referring to the illustration of FIG. 2A for the first preferred embodiment according to the present invention, the automatic-control wet paper molding machine 12 further comprises at least one vacuum intaking device 60 (such as a vacuum pump) respectively connected to the first dredging-pulp operation section 20, the second dredging-pulp operation section 20′, the thermo-compression forming operation section 40 and the cutting operation section 50, wherein the programmable control unit 80 programmably controls the at least one vacuum intaking device 60 gas-communicated respectively with said molds 22, 23, 22′, 23′, 41, 42 each defining a number of through vents 219, thereby respectively absorbing water/moistures contained within the first wet pulp, the second wet pulp, and the overlapped first and second pulp layers 101, 101′ in said different sections. Besides, by the at least one vacuum intaking device 60 programmably controlled from the programmable control unit 80, the first pulp layer 101 can be further suctioned via the through vents 219 of the first upper mold 22 so as to be brought with the movement of the first upper mold 22 together to reach the thermo-compression forming operation section 40, and the second pulp layer 101′ can be further suctioned via the through vents 219 of the second upper mold 22′ so as to be brought with the movement of the second upper mold 22′ together to reach the thermo-compression forming operation section 40. Besides, by the at least one vacuum intaking device 60 programmably controlled from programmable control unit 80, the semi-finished product 103 is suctioned via the number of through vents 219 of the third upper mold 41 so as to be brought with the movement of the third upper mold 41 together to reach the cutting operation section 50, for locating at a cutting position. The through vents 219 can be formed in a process when said respective molds 22, 23, 22′, 23′, 41, 42 are machined, including, for example, a wire cutting machining, a laser-beam machining, grinding or an electrical discharge machining and set forth.

In more details, referring to the illustration of FIG. 2A for the first preferred embodiment, the first upper mold 22, the second upper mold 22′ and the third upper mold 41 all are a convex male mold, and the first lower mold 23, the second lower mold 23′ and the third lower mold 42 all are a concave female mold, whereby the dredging-pulp surfaces of the first lower mold 23, the second lower mold 23′ and the third lower mold 42 all are as a concave top surface of the concave female mold. Thereamong, the dredging-pulp surface of the first lower mold 23 is disposed with a first woven net 231 thereon, the dredging-pulp surface of the second lower mold 23′ is disposed with a second woven net 231′ thereon, and the dredging-pulp surface of the third lower mold 42 is disposed with a third woven net 423 thereon. Each of the woven net 231, 231′, 423 all have a double-layer net-like structure, comprising a first inner woven net and a first outer woven net (not shown). A mesh number of the first outer woven net is larger than that of the first inner woven net, for facilitating each of the pulp layers 101, 101′ being kept on the corresponding woven nets 231, 231′, 423, and said woven net 231, 231′, 423 are designed to accelerate exhausting the water/moisture but to avoid a portion of each of the wet pulps being absorbed to enter the through vents 219 and therefore result in blocking the through vents 219, and to benefit increasing the surface smoothness of an inner surface and an outer surface of the molded-paper product such that the inner and outer surfaces of the molded-paper product renders smooth effects. In this preferred embodiment, the mesh number of each of the woven nets 231, 231′, 423 are from 20 to 120, and preferably, from 40 to 100, so as to avoid fracture or deformation upon suffering compression but to provide a sufficient mechanical strength. Generally speaking, each of the woven nets 231, 231′, 423 is made of a metallic material by way of one of twill weave, plain weave, dutch weave, dutch twilled weave and plain dutch weave. Preferably, said metallic material may be annealed stainless steel. However, it does not limit thereto and also use other non-metallic or metal alloy material in the present invention.

Please further refer to an illustration of FIG. 2B, which illustrates a structurally schematic diagram of an automatic-control wet paper molding machine 14 of a second preferred embodiment according to the present invention. Compared with said first preferred embodiment, the difference from this preferred embodiment is that: the first lower mold 23 of the automatic-control wet paper molding machine 14 is further disposed with a first dredging-pulp reverse device 70, and the second lower mold 23′ is disposed with a second dredging-pulp reverse device 70′, wherein the programmable control unit 80 programmably controls the first dredging-pulp reverse device 70 on actuating the first lower mold 23 being rotated by 180 degrees to position its dredging-pulp surface toward the first slurry tank 21 to sink into the first paper slurries 100, or back on to the first slurry tank 21 to upwardly leave far away from the first paper slurries 100. Also, the programmable control unit 80 programmably controls the second dredging-pulp reverse device 70′ on actuating the second lower mold 23′ being rotated by 180 degrees to position its dredging-pulp surface toward the first slurry tank 21′ to sink into the second paper slurries 100′, or back on to the first slurry tank 21′ to upwardly leave far away from the second paper slurries 100′. Each of the dredging-pulp reverse devices 70, 70′ can be a conventional device (as introduced in a Taiwanese utility model patent issued No. M516,615), which comprises at least one reverse shaft 72, 72′ connected to the respective lower molds 23, 23′ and an actuation assembly (e.g. an actuator) for driving the rotations of the shafts 72, 72′. In a case of using the first dredging-pulp operation section 20, when the actuation assembly actuates the reverse shaft 72 to rotate on its shaft axis by 180 degrees (i.e. to rotate either clockwise or anticlockwise) and then to bring the first lower mold 23 rotated such that the dredging-pulp surface of the first lower mold 23 is upwardly shifted out from the first paper slurries 100 of the first slurry tank 21, as rendering a dredging-pulp manner, or the dredging-pulp surface is downwardly sunk into the first paper slurries 100 of the first slurry tank 21, as rendering a suctioning-slurry manner. Furthermore, by the vacuum intaking device 60 programmably controlled from the programmable control unit 80 and respectively gas-communicated with the through vents 219 formed within the first lower mold 23 and the second lower mold 23′, when the dredging-pulp surface of the first lower mold 23 is downwardly sunk into the first paper slurries 100 of the first slurry tank 21 to be in the suctioning-slurry manner, the vacuum intaking device 60 can vacuum-suction the first paper slurries 100 onto the facing-downwardly dredging-pulp surface of the first lower mold 23, for forming the first wet pulp thereon. Also, when the dredging-pulp surface of the second lower mold 23′ is downwardly sunk into the second paper slurries 100′ of the second slurry tank 21′ to be in the suctioning-slurry manner, the vacuum intaking device 60 can vacuum-suction the second paper slurries 100′ onto the dredging-pulp surface of the second lower mold 23′, for forming the second wet pulp thereon. Since the other remaining structures and their actuation principle involved in the automatic-control wet paper molding machine 14 are mostly the same as described above for said automatic-control wet paper molding machine 12 of the first preferred embodiment, their relevant descriptions will be omitted hereinafter.

Please further refer to an illustration of FIG. 2C, which illustrates a structurally schematic diagram of an automatic-control wet paper molding machine 16 of a third preferred embodiment according to the present invention. Compared with said first preferred embodiment, the difference from this preferred embodiment is that: the first upper mold 22, the second upper mold 22′ and the third upper mold 41 of the automatic-control wet paper molding machine 16 all are a concave female mold, the first lower mold 23, the second lower mold 23′ and the third lower mold 42 all are a convex male mold, and the first upper mold 22, the second upper mold 22′ and the third upper mold 41 of all are collocated with a concave dredging-pulp surface that faces downwardly. Furthermore, the programmable control unit 80 is utilized to programmably control the at least one movable device 28 on downward actuation (as referring to a step S1), to facilitate the facing-downwardly dredging-pulp surface of the first upper mold 22 downwardly moving to sink into the first paper slurries 100 of the first slurry tank 21, as rendering a suctioning-slurry manner, and then facilitate the facing-downwardly dredging-pulp surface of the first upper mold 22 upwardly moving (as referring to a step S2) to shift out from the first paper slurries 100 of the first slurry tank 21, as rendering a dredging-pulp manner. Also, the programmable control unit 80 is utilized to programmably control the at least one movable device 28′ on downward actuation (as referring to a step S1′), to facilitate the facing-downwardly dredging-pulp surface of the second upper mold 22′ downwardly moving to sink into the second paper slurries 100′ of the second slurry tank 21′, as rendering the suctioning-slurry manner, and then facilitate the facing-downwardly dredging-pulp surface of the second upper mold 22′ upwardly moving (as referring to a step S2′) to shift out from the second paper slurries 100′ of the second slurry tank 21′, as rendering a dredging-pulp manner. By the programmable control unit 80 programmably controlling the vacuum intaking device 60 on gas-communication with the respective through vents 219 within the first upper mold 22 and the second upper mold 22′, when the facing-downwardly dredging-pulp surface of the first upper mold 22 is downwardly sunk into the first paper slurries 100 of the first slurry tank 21 as rendering the suctioning-slurry manner, the vacuum intaking device 60 is capable of respectively vacuum-suctioning the first paper slurries 100 onto the facing-downwardly dredging-pulp surface of the first upper mold 22, for forming the first wet pulp thereon, and when the facing-downwardly dredging-pulp surface of the second upper mold 22′ is downwardly sunk into the second paper slurries 100′ of the second slurry tank 21′ as rendering the suctioning-slurry manner, the at least one vacuum intaking device 60 vacuum-suctions the second paper slurries 100′ onto the facing-downwardly dredging-pulp surface of the second upper mold 22′, for forming the second wet pulp thereon. The programmable control unit 80 depends on the predetermined actuation sequence to programmably control in sequences as follows. While the programmable control unit 80 programmably controls the at least one movable device 28, 28′ on actuating both of the first upper mold 22 and the second upper mold 22′ in either downwardly suctioning slurries or upwardly dredging pulps, the first lower mold 23 and the second lower mold 23′ both are respectively moved to deviate from the movement routes of the first upper mold 22 and the second upper mold 22′ both to either suction slurries or dredge pulps (as respectively referring to steps S4, S4′); and then, the programmable control unit 80 further programmably controls the at least one movable device 29, 29′, 28, 28′ on respectively actuating both of the first lower mold 23 and the first upper mold 22, both of the second lower mold 23′ and the second upper mold 22′ in moving to reach the respective closing-mold positions for respectively implementing the first pre-compression step S3 and the second pre-compression step S3′, thereby respectively forming the first pulp layer 101 and the second pulp layer 101′. Since the other remaining structures and their actuation principle of the automatic-control wet paper molding machine 16 are mostly the same as described above for said automatic-control wet paper molding machine 12 of the first preferred embodiment, the relevant descriptions will be omitted hereinafter.

Further referring to an illustration of FIG. 2D, which illustrates a simplified schematically-structural diagram of an automatic-control wet paper molding machine of a fourth preferred embodiment 18 according to the present invention. Compared with said third preferred embodiment, the difference from this preferred embodiment is that: in the automatic-control wet paper molding machine 18, the first lower mold 23 and the third lower mold 42 both have the same or similar dimensions, and the second upper mold 22′ and the third upper mold 41 both have the same or similar dimensions; and preferably, convexes of top surfaces of both the first lower mold 23 and the third lower mold 42 have the same corner angle R0 and the same horizontal width w0, and concaves of bottom surfaces (namely the dredging-pulp surfaces) of the second upper mold 22′ and the third upper mold 41 both have the same corner angle R2 and the same horizontal width w2. When the first pulp layer 101 is formed by suffering from the compression between the first upper and lower molds 22, 23, since an upper surface of the first pulp layer 101 is formed with the same dimension as the corner angle R1 and the horizontal width w1 of the concave of the bottom surface (namely the dredging-pulp surface) of the first upper mold 22, and a bottom surface of the first pulp layer 101 is formed with the same dimension as the corner angle R0 and the horizontal width w0 of the convex of the top surface of the first lower mold 23 such that the first pulp layer 101 is capable of accurately fitting onto the convex of the top surface of the third lower mold 42; based on the same principle, when the second pulp layer 101′ is formed by suffering from the compression between the second upper and lower molds 22′, 23′, since an upper surface of the second pulp layer 101′ is formed with the same dimension as the corner angle R2 and the horizontal width w2 of the concave of the bottom surface (namely the dredging-pulp surface) of the second upper mold 22′, and a bottom surface of the second pulp layer 101′ is formed with the same dimension as the corner angle R1 and the horizontal width w1 of the convex of the top surface of the first upper mold 22, such that the bottom surface of the second pulp layer 101′ is capable of accurately fitting onto the upper surface of a convex of the first pulp layer 101, whereby the first pulp layer 101 and the second pulp layer 101′ both are further compressed together with tight incorporation with each other to be the semi-finished product 103.

Please further refer to a contrast between the illustrations of FIGS. 3A and 3B. FIG. 3A illustrates an operating sequence diagram of the respective operation sections of the conventional wet paper molding machine illustrated in FIG. 1, for producing a molded-paper product with a cross-sectional structure having double molded-paper layers, wherein the same dredging-pulp operation section 20 implements twice dredging-pulp and pre-compression steps in sequences and continuations, comprising a first dredging-pulp and pre-compression step with a need of spending a duty cycle T1, and a second dredging-pulp and pre-compression step with a need of spending a duty cycle T2. Since there is no time period overlapped or interleaved between the two duty cycles T1, T2, the conventional machine illustrated in FIG. 1 needs to spend the overall duty cycle (T1+T2) for finishing both of the first pulp layer and the second pulp layer; and then, manually delivering and overlapping both of the first pulp layer and the second pulp layer into the thermo-compression forming section 40 would spend a longer labor time than the aforementioned. Differently, with the controlled operation sequences of the respective operation sections in the automatic-control wet paper molding machine 12, 14, 16, 18 of said respective embodiments according to the present invention, as shown in FIG. 3B, for producing a molded-paper product comprising a cross-sectional structure having double molded-paper layers, the dredging-pulp operations of both of the first dredging-pulp operation section 20 and the second dredging-pulp operation section 20′ can be implemented synchronously (as synchronously finishing the first pulp layer 101 and the second pulp layer 101′). For example, in a controlled operation sequence diagram as illustrated in FIG. 3B, a first dredging-pulp and pre-compression step (as comprising the steps S1, S2) with a need of spending a first duty cycle T1, and a second dredging-pulp and pre-compression step (as comprising the steps S1′, S2′) with a need of spending a second duty cycle T2 can be programmably implemented in a manner that there is at least one time period n t interleaved between the first and second duty cycles T1, T2. Furthermore, a duty cycle T3 spent for programmably implementing the steps S3, S5 to move the first pulp layer 101 and a duty cycle T3′ spent for programmably implementing the steps S3′, S6 to move the second pulp layer 101′, both can be synchronous; a thermo-compression forming step S7 is programmably implemented for merely spending a single duty cycle T4, or the move steps S5 or S6 can be programmably implemented synchronously with another move step S8 or a cutting step S9. Thus, compared with said conventional machine, the present invention is capable of greatly shortening the overall duty cycles required for producing all of the layers. It should be noted that, the term “synchronously” is defined in a manner that there is a constant time interval Δt (Δt is smaller than each of T1 and T2) existed between starting-implementation time of the operation steps of more than two different operation sections. However, in other embodiments, the term “synchronously” can also be defined in another manner that the starting-implementation time of the operation steps of more than two different operation sections all are the same.

Please further refer to the illustrations of FIGS. 2A, 3B and 4. FIG. 4 illustrates a flow chart of an automatic-control wet paper molding method according to the present invention. It is convenient to realize these steps in the flow chart, accompanying with reference to the respective assemblies in the above-mentioned respective embodiments illustrated in FIGS. 2A and 3B. The method comprises:

utilizing a programmable control unit 80 to synchronously implement a first dredging-pulp step S1 and a second dredging-pulp step S1′ so as to respectively form a first pulp layer 101 and a second pulp layer 101′, wherein the first dredging-pulp step S1 comprises utilizing the programmable control unit 80 depending on a first duty cycle T1 to programmably control at least one movable device 28, 29 on respectively actuating either of a first upper mold 22 and a first lower mold 23, to dredge up first paper slurries 100 from within a first slurry tank 21 and thereby form the first pulp layer 101, and the second dredging-pulp step S1′ comprises utilizing the programmable control unit 80 depending on a second duty cycle T2 to programmably control the at least one movable device on 28′, 29′ on respectively actuating either of a second upper mold 22′ and a second lower mold 23′, to dredge up second paper slurries 100′ from within a second slurry tank 21′ and thereby form the second pulp layer 101′, wherein there is at least one time period n t interleaved between the first duty cycle T1 and the second duty cycle T2. In one preferred embodiment of the present invention, the automatic-control wet paper molding method further comprises: utilizing the programmable control unit 80 depending on the first duty cycle T1 to implement the following steps in sequences, comprising: the first dredging-pulp step S1 of programmably controlling the at least one movable device 28, 29 on actuating either of the first upper mold 22 and the first lower mold 23 in a first dredging-pulp action, to dredge up the first paper slurries 100 from the first slurry tank 21 and thereby form a first wet pulp; then, utilizing the programmable control unit 80 to programmably control the at least one vacuum intaking device 60 on absorbing water/moistures from the first wet pulp; and then, utilizing the programmable control unit 80 to programmably control the at least one movable device 28, 29 on actuating the first lower mold 22 in downwardly moving toward the first upper mold 23 to implement a step S2 of applying a first pre-compression on the first wet pulp to form the first pulp layer 101. In one preferred embodiment of the present invention, the automatic-control wet paper molding method further comprises: utilizing the programmable control unit 80 depending on the second duty cycle T2 to implement the following steps in sequences, comprising: the second dredging-pulp step S1′ to firstly programmably control the at least one movable device 28′, 29′ on actuating either of the second upper mold 22′ and the second lower mold 23′ in implementing a second dredging-pulp action to dredge up the second paper slurries 100′ from the second slurry tank 21′ and thereby form a second wet pulp; then, utilizing the programmable control unit 80 to programmably control the at least one vacuum intaking device 60 on absorbing water/moistures contained within the second wet pulp; and then utilizing the programmable control unit 80 to programmably control the at least one movable device on 28′, 29′ on actuating the second upper mold 22′ in downwardly moving toward the second lower mold 23′ to implement a step S2′ of applying a second pre-compression on the second wet pulp to form the second pulp layer 101′. In one preferred embodiment of the present invention, synchronous implementations of both of the first dredging-pulp step S1 and the second dredging-pulp step S1′ is defined in a manner that the first dredging-pulp step S1 and the second dredging-pulp step S1′ both start implementation at the same time t0, t0′ or the different time t0, t0′ which there is a constant time interval Δt between (Δt is smaller than each of T1 and T2); and

utilizing the programmable control unit 80 to programmably implement the following steps in sequences, comprising:

programmably implementing a first trans-regional move step S3, S5, wherein the first trans-regional move step S3, S5 comprises utilizing the programmable control unit 80 to programmably control the at least one movable device 28 on actuating the first upper mold 22 bringing the first pulp layer 101 to move together into a third lower mold 42, thereby positioning the first pulp layer 101 onto a top surface of the third lower mold 42. In this preferred embodiment, the first trans-regional move step S3, S5 further comprises utilizing the programmable control unit 80 to programmably control the at least one vacuum intaking device 60 on suctioning the first pulp layer 101, via the number of through vents 219 of the first upper mold 22, to be moved together with bringing of the first upper mold 22;

programmably implementing a second trans-regional move step S3′, S6, wherein the second trans-regional move step S3′, S6 comprises utilizing the programmable control unit 80 to programmably control the at least one movable device 28′ on actuating the second upper mold 22′ bringing the second pulp layer 101′ to move together into the third lower mold 42, thereby positioning the second pulp layer 101′ to overlap above the first pulp layer 101. In this preferred embodiment, the second trans-regional move step S3′, S6 further comprises utilizing the programmable control unit 80 to programmably control the at least one vacuum intaking device 60 on suctioning the second pulp layer 101′, via the number of through vents 219 of the second upper mold 22′, to be moved together with bringing of the second upper mold 22′;

programmably implementing a thermo-compression forming step S7, wherein the thermo-compression forming step S7 comprises utilizing the programmable control unit 80 to programmably control the at least one movable device 48, 49 on actuating both of the third upper mold 41 and the third lower mold 42 in applying an upward-and-downward thermo-compression on the overlapped first and second pulp layers 101, 101′, so as to incorporate with each other to form the semi-finished product 103. In this preferred embodiment, the thermo-compression forming step S7 further comprises utilizing the programmable control unit 80 to programmably control the at least one vacuum intaking device 60 on absorbing water/moistures contained within the overlapped first and second pulp layers 101, 101′;

programmably implementing a third trans-regional move step S8, wherein the third trans-regional move step S8 comprises utilizing the programmable control unit 80 to programmably control the at least one movable device 48 on actuating the third upper mold 41 bringing the semi-finished product 103 to move together, thereby then positioning the semi-finished product 103 into between at least one cutting mold assembly 51, 52. In this preferred embodiment, the third trans-regional move step S8 further comprises utilizing the programmable control unit 80 to programmably control the at least one movable device 48 on actuating the third upper mold 41 to move; and, utilizing the programmable control unit 80 to programmably control the at least one vacuum intaking device 60 on suctioning the semi-finished product 103, via the number of through vents 219 of the third upper mold 41, to be moved together with bringing of the third upper mold 41, thereby then positioning the semi-finished product 103 into between the at least one cutting mold assembly 51, 52; and

programmably implementing a cutting step S9, wherein the cutting step S9 comprises utilizing the programmable control unit 80 to programmably control the at least one movable device 58, 59 on actuating the at least one cutting mold assembly 51, 52 in cutting the semi-finished product 103, thereby then forming the molded-paper product 105 as illustrated in FIG. 5. In this preferred embodiment, either of the at least one cutting mold assembly 51, 52 may be a mechanically cutting mold assembly or laser-cutting apparatus, configured for cutting out exceeded edge portions of the semi-finished product 103 so as to achieve the molded-paper product 105.

In another preferred embodiment of the present invention, accompanying with reference to the illustration of FIG. 2B, the first dredging-pulp step S1 comprises: utilizing the programmable control unit 80 to programmably control the first dredging-pulp reverse device 70 on actuating the first lower mold 23 being rotated by 180 degrees to either sink into the first paper slurries 100, as rendering a suctioning-slurry manner, or leave far away from the first paper slurries 100, as rendering a dredge-pulp manner. And, the second dredging-pulp step S1′ further comprises: utilizing the programmable control unit 80 to programmably control the second dredging-pulp reverse device 70′ on actuating the second lower mold 23′ being rotated by 180 degrees to either sink into the second paper slurries 100′, as rendering the suctioning-slurry manner, or leave far away from the second paper slurries 100′, as rendering the dredge-pulp manner.

Besides, further referring to an illustration of FIG. 5, a laterally cross-sectional diagram of the molded-paper product 105 produced by said automatic-control wet paper molding method or said respective embodiments is illustrated. The molded-paper product 105 comprises a cross-sectional structure having double molded-paper layers (including, i.e. an upper layer and a lower layer). By the present invention, the molded-paper product 105 is fabricated to form an upper surface and a bottom surface therewith, both which have a surface smoothness larger than or equivalent to a Bekk smoothness of 3 seconds; and preferably, a Bekk smoothness of 6-14 seconds.

Compared with the conventional technology, the automatic-control wet paper molding machines 12, 14, 16, 18 according to the present invention can be respectively utilized where the respective operation sections 20, 20′, 40, 50 are respectively connected to each other, and the programmable control unit 80 is employed to programmably control in sequences said respective actuations of the at least one movable device 28, 28′, 29, 29′, 48, 49, 58, 59 and the at least one vacuum intaking device 60 on respectively suctioning the first pulp layer 101, the second pulp layer 101′ and the semi-finished product 103 to move among the corresponding operation sections 20, 20′, 40, 50. Thus, the respective automatic-control wet paper molding machines 12, 14, 16, 18 according to the present invention are capable of accomplishing a consistent and successive operation in a completely automated production line mode, without the need of manually delivering and then accurately positioning the first pulp layer 101, the second pulp layer 101′ and the semi-finished product 103 thereamong. Furthermore, the respective automatic-control wet paper molding machines 12, 14, 16, 18 and the automatic-control wet paper molding method according to the present invention are suitable to massively and rapidly automation-produce the molded-paper products each which comprises a cross-sectional structure having double molded-paper layers; and especially, utilize the programmable control unit 80 to programmably control the following steps in sequences, including: synchronizing dredging-pulp operations of both of the first dredging-pulp operation section 20 and the second dredging-pulp operation section 20′ to rapidly form the first pulp layer 101 and the second pulp layer 101′; moving the first pulp layer 101 into the thermo-compression forming operation section 40, and then moving the second pulp layer 101′ to overlap above the first pulp layer 101 of the thermo-compression forming operation section 40; and thermally compressing the overlapped first and second pulp layers 101, 101′ to incorporate with each other to form a semi-finished product, thereby shortening the overall duty cycle and labor costs thereof, elevating an operating efficiency thereof, and shaping accurately different dimensions required respectively for the double molded-paper layers in the cross-sectional structure.

As described above, although the present invention comprises been described with the preferred embodiments thereof, those skilled in the art will appreciate that various modifications, additions, and substitutions are possible without departing from the scope and the spirit of the invention. Accordingly, the scope of the present invention is defined only by reference to the claims.

What is claimed is:

1. An automatic-control wet paper molding machine, comprising:
a frame;
at least one movable device, disposed to the frame;
a first dredging-pulp operation section, mechanically connected to the at least one movable device and disposed with a first slurry tank, a first upper mold and a first lower mold;
a second dredging-pulp operation section, mechanically connected to the at least one movable device and disposed with a second slurry tank, a second upper mold and a second lower mold;
a thermo-compression forming operation section, mechanically connected to the at least one movable device and respectively neighbored to both of the first dredging-pulp operation section and the second dredging-pulp operation section, having a third upper mold and a third lower mold; and
a programmable control unit;
wherein the programmable control unit depends on a first duty cycle to programmably control the at least one movable device on actuating either of the first upper mold and the first lower mold to dredge up first paper slurries from the first slurry tank and thereby form a first pulp layer, the programmable control unit depends on a second duty cycle to programmably control the at least one movable device on actuating either of the second upper mold and the second lower mold to dredge up second paper slurries from the second slurry tank and thereby form a second pulp layer, wherein there is at least one time period interleaved between the first duty cycle and the second duty cycle, and the programmable control unit depends on a predetermined actuation sequences to firstly programmably control the at least one movable device on actuating the first upper mold bringing the first pulp layer to move together from the first dredging-pulp operation section to reach the thermo-compression forming operation section, for positioning the first pulp layer to the third lower mold, then programmably control the at least one movable device on actuating the second upper mold bringing the second pulp layer to move together from the second dredging-pulp operation section to reach the thermo-compression forming operation section, for positioning the second pulp layer to overlap above the first pulp layer, and then programmably control the at least one movable device on actuating both of the third lower mold and the third upper mold in applying a thermo-compression on the overlapped first and second pulp layers to incorporate with each other to form a semi-finished product.

2. The automatic-control wet paper molding machine as claimed in claim 1, wherein the programmable control unit depends on the first duty cycle to programmably control the at least one movable device on actuating either of the first upper mold and the first lower mold in a first dredging-pulp to dredge up the first paper slurries from the first slurry tank and thereby form a first wet pulp thereon, and then programmably control the at least one movable device on actuating both of the first lower mold and the first upper mold in implementing a first pre-compression on the first wet pulp to form the first pulp layer.

3. The automatic-control wet paper molding machine as claimed in claim 2, wherein the programmable control unit depends on the second duty cycle to programmably control the at least one movable device on actuating either of the second upper mold and the second lower mold in a second dredging-pulp to dredge up the second paper slurries from the second slurry tank and thereby form a second wet pulp, and then programmably control the at least one movable device on actuating both of the second lower mold and the second upper mold in implementing a second pre-compression on the second wet pulp to form the second pulp layer.

4. The automatic-control wet paper molding machine as claimed in claim 3, further comprising at least one vacuum intaking device, wherein the programmable control unit is used to programmably control the at least one vacuum intaking device on respectively absorbing water/moistures contained within the first wet pulp, the second wet pulp and the overlapped first and second pulp layers, and further programmably control the at least one vacuum intaking device on respectively suctioning the first pulp layer, via a number of through vents formed within the first upper mold, to be moved together with bringing of the first upper mold, and respectively suctioning the second pulp layer, via a number of through vents formed within the second upper mold, to be moved together with bringing of the second upper mold.

5. The automatic-control wet paper molding machine as claimed in claim 1, further comprising a cutting operation section, which is disposed with the frame and neighbored to the thermo-compression forming operation section, having at least one cutting mold assembly, wherein the programmable control unit depends on the predetermined actuation sequences to firstly programmably control the at least one movable device on actuating the third upper mold bringing the semi-finished product to move together from the thermo-compression forming operation section to reach the cutting operation section, for positioning the semi-finished product into between the at least one cutting mold assembly, and then programmably control the at least one movable device on actuating the at least one cutting mold assembly in cutting the semi-finished product.

6. The automatic-control wet paper molding machine as claimed in claim 1, wherein the programmable control unit comprises at least one programmable controller and a number of sensors electrically connected to the programmable controller, the at least one programmable controller is configured to control the actuations of the at least one movable device, the sensors are configured to respectively sense a physical information relative to under the respective controlled actuations of the at least one movable device, and then feedback the physical information to the at least one programmable controller.

7. The automatic-control wet paper molding machine as claimed in claim 1, wherein the first paper slurries and the second paper slurries both have different colors.

8. The automatic-control wet paper molding machine as claimed in claim 1, wherein the first paper slurries and the second paper slurries both have different average fiber lengths or compositions.

9. The automatic-control wet paper molding machine as claimed in claim 1, wherein the first lower mold and the third lower mold both have the same or similar dimensions, and the second upper mold and the third upper mold both have the same or similar dimensions.

10. The automatic-control wet paper molding machine as claimed in claim 1, wherein the first lower mold has a first dredging-pulp reverse device, and the second lower mold has a second dredging-pulp reverse device, wherein the programmable control unit programmably controls the first dredging-pulp reverse device on actuating the first lower mold being rotated by 180 degrees to either sink into or leave far away from the first paper slurries, and the programmable control unit programmably controls the second dredging-pulp reverse device on actuating the second lower mold being rotated by 180 degrees to either sink into or leave far away from the second paper slurries.

11. An automatic-control wet paper molding method, comprising:
utilizing a programmable control unit to synchronously implement a first dredging-pulp step and a second dredging-pulp step, wherein the first dredging-pulp step further comprises utilizing the programmable control unit depending on a first duty cycle to programmably control at least one movable device on actuating either of a first upper mold and a first lower mold to dredge up first paper slurries from within a first slurry tank and thereby form a first pulp layer thereon, and the second dredging-pulp step further comprises utilizing the programmable control unit depending on a second duty cycle to programmably control the at least one movable device on actuating either of a second upper mold and a second lower mold to dredge up second paper slurries from within a second slurry tank and thereby form a second pulp layer thereon, wherein there is at least one time period interleaved between the first duty cycle and the second duty cycle; and
utilizing the programmable control unit to programmably implement the following steps in sequences, including:
programmably implementing a first trans-regional move step which comprises utilizing the programmable control unit to programmably control the at least one movable device on actuating the first upper mold bringing the first pulp layer to move together into a third lower mold, and then positioning the first pulp layer onto the third lower mold;
then programmably implementing a second trans-regional move step which comprises utilizing the programmable control unit to programmably control the at least one movable device on actuating the second upper mold bringing the second pulp layer to move together into the third lower mold, and then positioning the second pulp layer to overlap above the first pulp layer; and
then programmably implementing a thermo-compression forming step which comprises utilizing the programmable control unit to programmably control the at least one movable device on actuating both of a third upper mold and a third lower mold in applying an upward-and-downward thermo-compression on the overlapped first and second pulp layers to incorporate with each other to form a semi-finished product.

12. The automatic-control wet paper molding method as claimed in claim 11, further comprising utilizing the programmable control unit depending on the first duty cycle to implement the following steps in sequences, comprising:
the first dredging-pulp step which comprises programmably controlling the at least one movable device on actuating either of the first upper mold and the first lower mold in a first dredging-pulp to dredge up the first paper slurries from the first slurry tank and thereby form a wet pulp;
then programmably controlling at least one vacuum intaking device on absorbing water/moistures contained within the first wet pulp; and
then programmably controlling the at least one movable device on actuating both of the first lower mold and the first upper mold in implementing a step of applying a first pre-compression on the first wet pulp to form the first pulp layer.

13. The automatic-control wet paper molding method as claimed in claim 12, further comprising utilizing the programmable control unit depending on the second duty cycle to implement the following steps in sequences, comprising:
the second dredging-pulp step which comprises firstly programmably controlling the at least one movable device on actuating either of the second upper mold and the second lower mold in a second dredging-pulp to dredge up the second paper slurries from the second slurry tank and thereby form a second wet pulp;
then programmably controlling the at least one vacuum intaking device on absorbing water/moistures contained within the second wet pulp; and
then programmably controlling the at least one movable device on actuating both of the second lower mold and the second upper mold in implementing a step of applying a second pre-compression on the second wet pulp to form the second pulp layer.

14. The automatic-control wet paper molding method as claimed in claim 13, wherein the thermo-compression forming step further comprises utilizing the programmable control unit to programmably control the at least one vacuum intaking device on absorbing water/moistures contained within the overlapped first and second pulp layers, the first trans-regional move step further comprises utilizing the programmable control unit to programmably control the at least one vacuum intaking device on suctioning the first pulp layer, via a number of through vents formed within the first upper mold, to be moved together with bringing of the first upper mold, and the second trans-regional move step further comprises utilizing the programmable control unit to programmably control the at least one vacuum intaking device on suctioning the second pulp layer, via a number of through vents formed within the second upper mold, to be moved together with bringing of the second upper mold.

15. The automatic-control wet paper molding method as claimed in claim 11, wherein synchronous implementations of both of the first dredging-pulp step and the second dredging-pulp step is defined in a manner that the first dredging-pulp step and the second dredging-pulp step both start implementation at the same time, or different time which there is a constant time interval between.

16. The automatic-control wet paper molding method as claimed in claim 11, further comprising programmably implementing a third trans-regional move step which comprises utilizing the programmable control unit to programmably control said at least one movable device on actuating the third upper mold bringing the semi-finished product to move together and then positioning the semi-finished product into between at least one cutting mold assembly.

17. The automatic-control wet paper molding method as claimed in claim 15, further comprising programmably implementing a cutting step which further comprises utilizing the programmable control unit to programmably control the at least one movable device on actuating the at least one cutting mold assembly in cutting the semi-finished product.

18. The automatic-control wet paper molding method as claimed in claim 11, wherein the first dredging-pulp step further comprises utilizing the programmable control unit to programmably control a first dredging-pulp reverse device on actuating the first lower mold being rotated by 180 degrees to either sink into or leave far away from the first paper slurries, and the second dredging-pulp step further comprises utilizing the programmable control unit to programmably control a second dredging-pulp reverse device on actuating the second lower mold being rotated by 180 degrees to either sink into or leave far away from the second paper slurries.

19. A molded-paper product is fabricated by the automatic-control wet paper molding method as claimed in claim 11.

20. The molded-paper product as claimed in claim 19, comprising a cross-sectional structure having double molded-paper layers.
